(19) United States
(12) Patent Application Publication
(10) Pub. No.: US 2005/0206600 A1
(43) Pub. Date: Sep. 22, 2005

(54) Structure of semiconductor chip and display device using the same

(75) Inventors: Daigo Miyasaka, Tokyo (JP); Hiroshi Hayama, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: NEC Corporation

(21) Appl. No.: 11/072,431

(22) Filed: Mar. 7, 2005

(30) Foreign Application Priority Data
Mar. 16, 2004 (JP) 2004-074365

(51) Int. Cl. G09G 3/36

(52) U.S. Cl. 345/92

(57) ABSTRACT

Provided is a structure which is capable of narrowing a semiconductor chip in width and a display device which is narrowed in frame by using the same. In the structure of a semiconductor chip provided such that the semiconductor chip is mounted on a glass substrate and a plurality of power lines (a first wiring and a second wiring) of the semiconductor chip are extended in a continuous direction so as to form, the structure of the semiconductor chip comprises the power lines with different electric potentials, which is formed by overlapping. Rather than making a capacity at the overlapped area of wirings and forming the wiring alone, a wiring which is narrowed in width may be achieved.

### BACKGROUND OF THE INVENTION

1. Field of the Invention

The present invention relates to a mounting object of a semiconductor chip and a display device using the same, and in particular to an area reduction of a semiconductor chip.

2. Description of the Related Art

In recent years, a display device with liquid crystal and organic electroluminescence etc. is available for use as a display with thin and light in various fields such as notebook computers and mobile phones. For further offering reductions in thickness, area and weight, narrowing in frame (or trim); that is, reducing areas except a display screen is required.

In a frame unit of a display device, a semiconductor chip is mounted for driving the pixel of a display unit. The semiconductor chip is mounted on the frame unit of the display device such as by TAB (Tape Automated Bonding) and COG (Chip On Glass) methods. At any method, it is efficient for narrowing in frame and coming down in weight to reduce the area of a semiconductor chip and especially to narrow the width of the semiconductor chip. In particular, at the COG method, the protruding electrode (bump) of a semiconductor chip and the frame unit of a substrate in a display device are directly connected with a conductive adhesive, such as an anisotropic conductive film (ACF). As a result, the width of a semiconductor chip has an influence on narrowing in frame of the display device directly. In addition, on the periphery of the semiconductor chip mounted on this display device, a capacitor is provided for smoothing and pressuring-up of a DC-DC converter according to need. Making the footprint (or mounted area) of such capacitors to be smaller also leads to narrow in frame of the display device.

Here, the two kinds of conventional art are recited below as methods of narrowing in frame of a display device. The first conventional art is an example of the way of a configuration for a capacitor (Patent Document 1) and the second conventional art is an example of the way of formation for a semiconductor chip (Patent Document 2).

The first conventional art, in a liquid crystal display device in which a semiconductor chip is mounted on a frame part, is to acquire a liquid crystal display device with small-sized at low cost by providing a plurality of smoothing capacitors or pressuring-up capacitors therein as a capacitor array.

On the other hand, in the second conventional art, the semiconductor chip for driving a display device is to be as a glass substrate approximately with the same length as a screen, configures a driving circuit thereon, and connects to the glass substrate for display thereby reducing routed areas of wiring in the glass substrate for display. Thus, an area reduction in a driving circuit mounting part is approached.

Patent Document 1: Japanese Patent Application Laid-open No. 2002-169176 (page 3, FIG. 1)
Patent Document 2: Japanese Patent Application Laid-open No. 2000-214477 (page 3, FIG. 1)

However, in the first conventional art, it is unchangeable that a capacitor chip is still mounted and the footprint would not be reduced greatly even as a capacitor array.

On the other hand, in the second conventional art, by employing a driving circuit glass substrate, the routed area of a wiring is reduced. Although narrowing in frame can be realized as a whole, when the size of the driving circuit glass substrate is longer than the one of a general silicon chip, the capacitor chip is provided, according to need, for minimizing the influence by a voltage drop in the wiring.

### SUMMARY OF THE INVENTION

An object of the present invention is conceived in view of such problems. The main object is, in a structure of a semiconductor chip, to minimize the number of a capacitor provided on the periphery of a semiconductor chip, further to provide the structure of a semiconductor chip which is capable of narrowing the semiconductor chip in width, and then to offer a display device which is narrowed in frame by using the same.

In order to achieve the object, the structure of a semiconductor chip according to the present invention comprises: a semiconductor chip which has a semiconductor circuit; and a pair of power lines for supplying a voltage to the semiconductor circuit whose electric potentials are different, wherein the pair of power lines are to be confronted across a dielectric as an electrode plate thereby a capacitor is configured by the power lines and the dielectric. As the dielectric, an insulating layer which electrically insulates between the pair of power lines is used.

The pair of power lines are formed in an elongated planar shape and the entire area is confronted. Or a part of the confronting area in the pair of power lines is enlarged so as to increment a capacitance. Additionally, only branches with a narrow width provided in the pair of power lines are to be confronted across the dielectric. The branches with a narrow width may be arrayed plural in a longitudinal direction of the power lines.

The pair of power lines may be shifted and disposed onto the string of terminals formed on the other side, opposite of which of the semiconductor chip in which the string of output terminals of the semiconductor circuit is formed. The pair of power lines may be formed inside the semiconductor chip or may be formed on a different substrate from the semiconductor chip. Also, as the semiconductor chip, it is preferable to employ a structure in which the semiconductor circuit is formed on the glass substrate.

The structure of a semiconductor chip according to the present invention can be applied to a display device. This display device includes: a display unit with a plurality of display pixels in a matrix shape; a semiconductor chip which has a semiconductor circuit for driving a display pixel of the display unit; a pair of power lines whose electric potential are different for applying a voltage to the semiconductor circuit; and a capacitor in which the pair of power lines are to be confronted across a dielectric as an electrode plate and whereby a capacitor is configured by the power lines and the dielectric.

As explained above, according to the present invention, it is to configure a capacitor by using a pair of power lines whose electric potentials are different for applying a voltage to the semiconductor circuit of a semiconductor chip. Consequently, it is not needed to provide the power lines and a separate capacitor as before; that is, the size of the counterpart equipment on which the structure of a semiconductor chip according to this invention is mounted can be miniaturized.

Moreover, since a pair of power lines are confronted as an electrode plate, the capacitance between these power lines increases in proportion to the overlapped area of the power lines, so applying a semiconductor chip to a glass substrate at a comparatively large area makes it possible to have an enough overlap of power lines, and thus the effect is large.

Furthermore, since a pair of power lines have a capacitance portion, it allows for suppressing a drop in voltage of power lines whereby enabling the wiring width of the power lines to narrow as compared with power lines without a capacitance portion. This allows a contribution toward miniaturization of element size.

Still further, when there is a shortage of the capacitance in which power lines have, the capacitance could be increased if the confronting area (overlapped area) of a pair of power lines increments. This method is more advantageous when the power lines are formed on a separate substrate from a semiconductor chip than when the power lines are included inside the semiconductor chip.

A pair of power lines are to apply a voltage to the semiconductor circuit of a semiconductor chip. Accordingly, it is inevitable that its whole length becomes longer and with this a wiring resistance becomes larger. Thereby, depending on the longitudinal direction, variations in voltage are caused. The present invention is to make only branches with a narrow width, which is provided in the pair of power lines, confronted across a dielectric. By arraying the branches plural with a narrow width in a longitudinal direction of the power lines, the variations in voltage can be suppressed.

Further, the structure of a semiconductor chip according to this invention can miniaturize its size by applying it to the capacitor of a pair of power lines. Consequently, when applying the structure of this semiconductor chip to the display device, it can be contributed to miniaturization of the display device.

### BRIEF DESCRIPTION OF THE DRAWINGS

FIG. 1 is a plan view of a liquid crystal display device according to a first embodiment of the present invention;

FIG. 2 is a plan view of a semiconductor chip for driving scan lines according to a first embodiment of the present invention;

FIG. 3 is a cross-sectional view of a semiconductor chip for driving scan lines according to a first embodiment of the present invention;

FIG. 4 is a plan view of a semiconductor chip for driving signal lines according to a first embodiment of the present invention;

FIG. 5 is an example of another wiring configuration inside the semiconductor chip for driving scan lines according to a first embodiment of the present invention;

FIG. 6 is a plan view of a semiconductor chip for driving scan lines according to a second embodiment of the present invention;

FIG. 7 is an example of another wiring configuration of a semiconductor chip for driving scan lines according to a second embodiment of the present invention;

FIG. 8 is a plan view of a semiconductor chip for driving scan lines according to a third embodiment of the present invention;

FIG. 9 is a cross-sectional view of a semiconductor chip for driving scan lines according to a third embodiment of the present invention;

FIG. 10 is a plan view of a liquid crystal display device according to a fourth embodiment of the present invention;

FIG. 11 is a plan view of a semiconductor chip for driving scan lines according to a fourth embodiment of the present invention;

FIG. 12 is a cross-sectional view of a semiconductor chip for driving scan lines according to a fourth embodiment of the present invention;

FIG. 13 is a cross-sectional view showing an example of another wiring configuration inside the semiconductor chip for driving scan lines according to a fourth embodiment of the present invention;

FIG. 14 is a plan view of a liquid crystal display device having a configuration in which a semiconductor chip is placed on a flexible substrate according to a fifth embodiment of the present invention;

FIG. 15 is a plan view of a semiconductor chip for driving signal lines according to a fourteenth embodiment of the present invention;

FIG. 16 is a plan view of another configuration example of a liquid crystal display device having a configuration in which a semiconductor chip is placed on a flexible substrate according to a fifth embodiment of the present invention;

FIG. 17 is a plan view of a semiconductor chip for driving signal lines according to a sixteen embodiment of the present invention;

FIG. 18 is a plan view of a liquid crystal display device having a configuration in which a semiconductor chip is placed on a printed board according to a fifth embodiment of the present invention; and

FIG. 19 is a plan view of a semiconductor chip for driving signal lines according to an eighteenth embodiment of the present invention.

### DESCRIPTION OF THE PREFERRED EMBODIMENTS

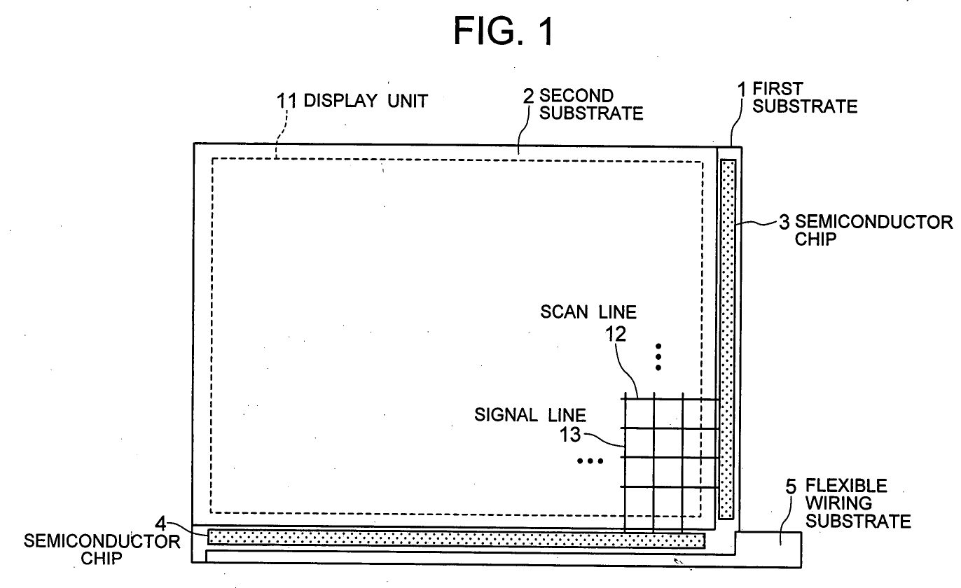

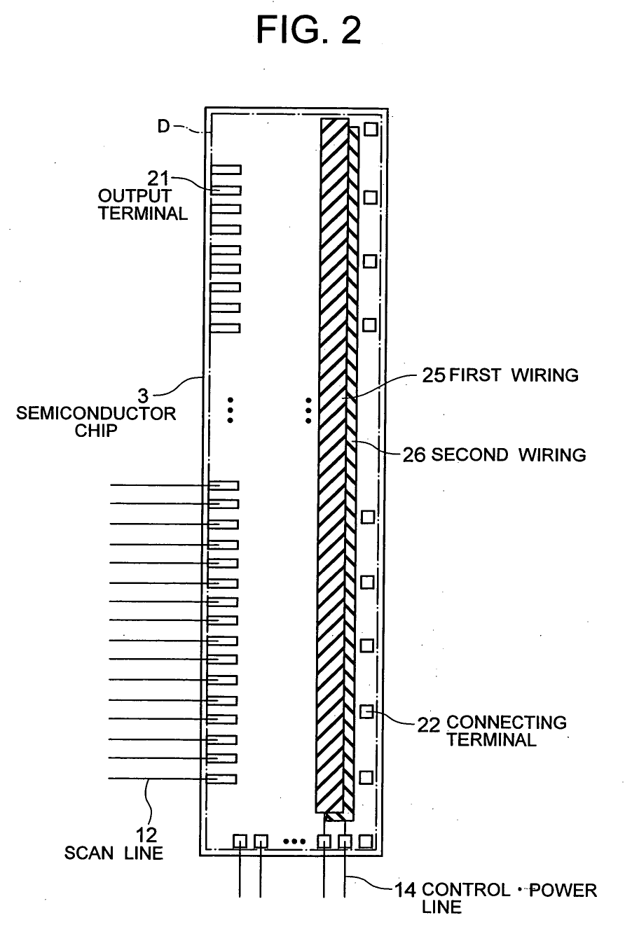

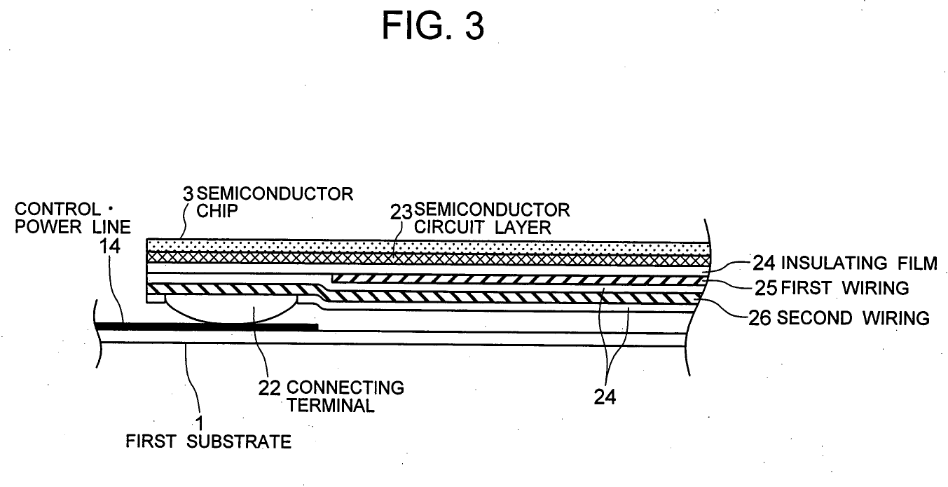

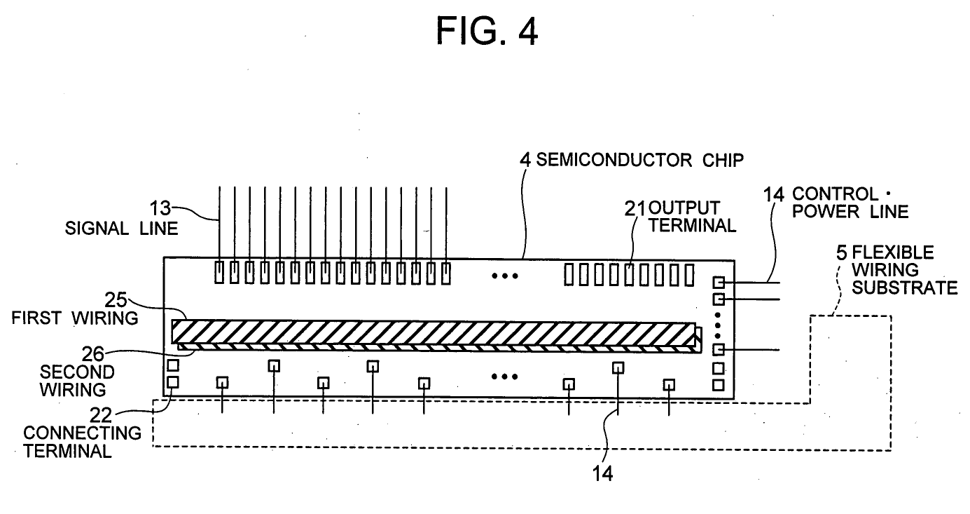

With respect to a first embodiment of the present invention, the plan view of a liquid crystal display device shown in FIG. 1, the structures of a semiconductor chip in FIG. 2 and FIG. 4, and the cross-sectional view of a semiconductor chip and a liquid crystal display device in FIG. 3 will be described as examples.

The liquid crystal display device of FIG. 1 includes a first substrate 1 and a transparent second substrate 2. The two of the substrates 1 and 2 face across a liquid crystal layer (not shown) therebetween and are bonded together with a sealing material. As the first substrate 1 and the transparent second substrate 2, a glass substrate is mostly used. Of course, as long as a liquid crystal display device can be realized, a plastic substrate or the like may be possible. In the FIG. 1, the configuration of the first substrate 1 is protruded at the right and lower sides compared to the transparent second substrate 2. This protruded portion is a frame part where semiconductor chips 3 and 4 are mounted through an ACF. Although the detail descriptions of the semiconductor chips 3 and 4 will be discussed later, a circuit for driving liquid crystal and the like are mounted. Additionally, a flexible wiring substrate 5 for inputting signals for driving the liquid crystal display device and power voltage is mounted on the first substrate 1. The signals from the flexible wiring substrate 5, not shown, are to be transmitted to the semiconductor chips 3 and 4 or the like through a wiring provided on the first substrate 1.

The area as shown by dotted lines indicates a display unit 11. The display unit 11 at least comprises: a plurality of scan lines 12 and a plurality of signal lines 13 which cross each other on a first substrate 1; and a plurality of pixels (not shown) formed on the points of intersection of the scan lines 12 and the signal lines 13 and arrayed in a matrix shape, wherein a transparent second substrate 2 is so configured that a transparent electrode is at least included. The plurality of pixels are provided for each intersection of the plurality of scan lines 12 and the plurality of signal lines 13 on a pixel array unit in the matrix shape through a thin film transistor (TFT). Then, a semiconductor chip 3 for driving scan lines which executes a signal control for outputting to the plurality of scan lines 12 and a semiconductor chip 4 for driving signal lines which executes a signal control for outputting to the plurality of signal lines 13 are connected to the scan lines 12 and the signal lines 13 respectively thereby driving pixels of the display unit 11.

FIG. 2 is a plan view of a semiconductor chip 3 which is shown in FIG. 1 seen from the paper. The semiconductor chip 3 has a configuration in which a driving circuit (semiconductor circuit indicated by alternate long and short dashed lines) D is formed on a glass substrate in an elongated shape. This semiconductor chip 3 is mounted face-down on a first substrate 1, therefore, as illustrated in the FIG. 2, output terminals 21 and connecting terminals 22 of the driving circuit D are provided at the mounted plane side of the first substrate 1 of the semiconductor chip 3. The output terminals 21 and the connecting terminals 22 are protruding electrodes. In the drawing, the output terminals 21 are placed parallel to a side (here refers to the left side) of the display unit 11, which is extended in a continuous direction of the semiconductor chip 3. Also, each of the output terminals 21 are respectively connected to the scan lines 12. In addition, the connecting terminals 22 are placed parallel to the opposite side of where the output terminals 21 of the semiconductor chip 3 exist (here refers to the right side). Further, the connecting terminals 22 are placed in the remaining sides of the semiconductor chip 3. In these connecting terminals 22, control lines•power lines 14 are connected for driving the semiconductor chip 3. The control lines•power lines 14 are formed on the first substrate 1. Also, the power lines 14, and a first wiring 25 and a second wiring 26 whose electric potential are different connected to the power lines 14 are formed in a longitudinal direction within the semiconductor chip 3. The first wiring and the second wiring 26 are formed in an elongated shape and, as an electrode plate, the entire area is confronted across a dielectric. Thereby, a capacitor is to be configured by the first wiring 25, the second wiring 26 and the dielectric. As the above-mentioned dielectric, an insulating layer which electrically insulates between the two wirings 25 and 26 is used.

FIG. 3 is a cross-sectional view of which includes the first wiring 25, the second wiring 26 and the control line•power line 14 in the semiconductor chip 3 shown in FIG. 2. The semiconductor chip 3 is formed in the order of a semiconductor circuit layer 23, an insulating film 24, a first wiring 25 as a first wiring layer, an insulating film 24, a second wiring 26 and a connecting terminal 22 as a second wiring layer, and an insulating film 24 at multilayer. The insulating film 24 is formed by silicon nitride or the like. Between the semiconductor circuit layer 23 and the first wiring layer and the second wiring layer are connected through a contact provided in an optional point on the insulating film 24. The part where the second wiring layer is not covered with the insulating film 24, the connecting terminals 22 is formed in the shape of a dome by electroless plating or the like. Yet, an output terminal 21 is also formed in the same process. This dome-shaped connecting terminal 22 is connected by a control line•power line 14 on a first substrate 1 directly or an electrically conductive particle (not shown) which is dispersed inside resin electrically.

A first wiring 25 and a second wiring 26 are connected with a single or a plurality of connecting terminals 22. In the FIG. 3, the second wiring 26 is connected with the connecting terminal 22. The first wiring 25 is also connected with, not shown, another connecting terminal 22.

FIG. 4 is a plan view of a semiconductor chip 4 which is shown in FIG. 1 seen from the paper. Similar to FIG. 2, output terminals 21 and connecting terminals 22 of a driving circuit D are provided at the mounted plane side of a first substrate 1 of the semiconductor chip 4 shown in FIG. 4. In the FIG. 4, the output terminals 21 are placed parallel to a side (here refers to the upside) of a display unit 11, which is extended in a continuous direction of the semiconductor chip 4, and each of them is respectively connected with signal lines 13. Also, a part of the connecting terminals 22 is placed parallel to the opposite side of where the output terminals 21 of the semiconductor chip 4 exist (here refers to the downside) and the remaining sides of the semiconductor chip 4 and then is connected to control lines•power lines 14 for driving the semiconductor chip 4. The difference in connection with a semiconductor chip 3 shown in FIG. 2 is that a control line•power line 14 extended from a connecting terminal 22 which is arranged in the downside in FIG. 4 is connected with a flexible wiring provided in a flexible wiring substrate 5. The flexible wiring of the flexible wiring substrate 5 is to supply a control signal•voltage to a control line•power line 14.

Next, operations and effects will be described in the embodiments of the present invention.

As illustrated in FIG. 1, the semiconductor chips 3 and 4 shown in this embodiment are so provided, corresponding to scan lines 12 and signal lines 13 respectively, as to be for driving scan lines and for driving signal lines for each. The length of the long side is approximately at the one of each side of a display unit 11 in the display device. As the pitch of an output terminal 21 is closer to the ones of a scan line 12 and signal line 13, the area of routed wiring for connecting to each scan line 12 and signal line 13 from an output terminal 21 of semiconductor chips 3 and 4 becomes smaller. Hence, it is preferable that these pitches are brought to as closer as possible. Also, considering the acquired number per sheet and the cost, it is desirable that the semiconductor chips 3 and 4 with such large areas are a driving circuit chip formed from a glass substrate. The effect of the present invention is thus larger as a wiring is needed to be extended in the continuous direction.

Inside the semiconductor chip 3 of FIG. 2, a driving circuit D is formed substantially throughout the entire chip so as to minimize the width of the chip. As a power source voltage for actuating the driving circuit D is further from a power source, its voltage drop becomes larger. Thus, it is necessary to thicken a wiring so as a value of resistance per unit length at the same material to be lower. Hence, as power lines with different electric potentials, a first wiring 25 and a second wiring 26 are used. Because the first wiring 25 and the second wiring 26 are configured in planar by overlapping, a capacitance is formed between the first wiring 25 and the second wiring 26. In the semiconductor chips 3 and 4 illustrated in this embodiment, a first wiring 25 and a second wiring 26 are extended in a continuous direction. The capacitance between the power lines is proportional to the overlapped area so that the large capacity may be obtained. When a capacitance is formed between the power lines, a temporal voltage drop by the flow of a current to a load can be made smaller than when it is not formed.

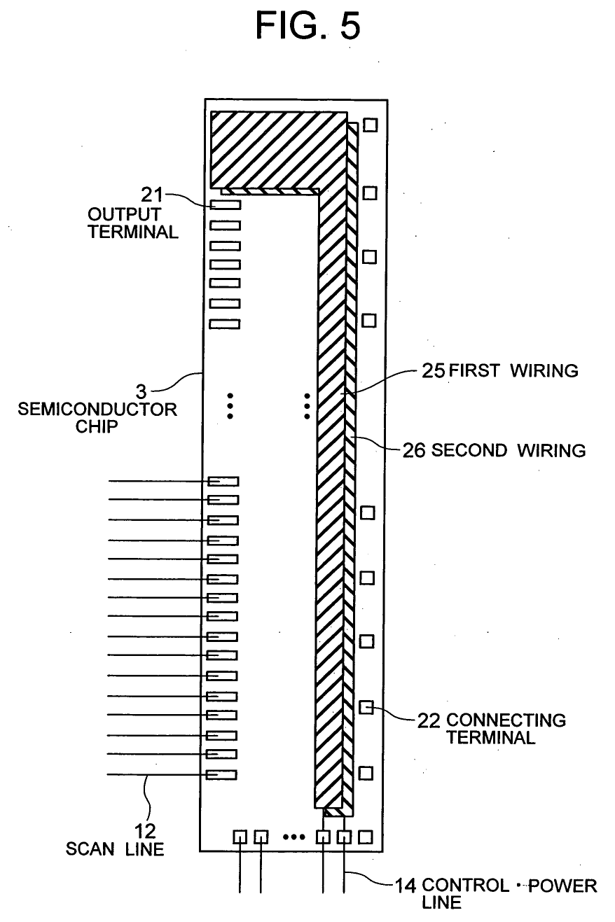

Also, as a method for increasing the overlapped area of power lines, a configuration, like shown in FIG. 5, of a first wiring 25 and a second wiring 26 is proposed. In the FIG. 5, a voltage is applied to the first wiring 25 and the second wiring 26 through control lines•power lines 14 of the downside of a semiconductor chip 3. Consequently, by forming a large overlapped area from the first wiring 25 and the second wiring 26 on the upside of the semiconductor chip 3, a configuration is provided such that a voltage drop at a remote edge of a power line can be more suppressed.

In a semiconductor chip 4 of FIG. 4, the amount of current consumption is larger when compared with the one in a semiconductor chip 3 for driving scan lines, therefore, a flexible wiring which corresponds to a low resistance wiring is provided adjacent to the semiconductor chip 4. With this configuration, a voltage drop inside the semiconductor chip 4 can be decreased by forming a capacitance between the power lines inside the semiconductor chip 4. Thereby the effect of this invention can be obtained.

As described above, forming power lines, whose electric potential are different, by overlapping intentionally allows for the formation of a capacitance between power lines. The capacitance of these power lines becomes larger proportional to the overlapped area of the power lines. Accordingly, the substantial overlap of power lines can be provided by applying to the above-mentioned driving circuit glass substrate where a semiconductor chip is relatively a large area. Thus, the effect is high. The wiring width of a power line may be made narrower when compared with the case provided alone.

By the aforementioned effect, the configuration which is narrowed in width of a semiconductor chip can be obtained and a display device with a narrower frame may be provided.

Note that, in this embodiment, although a configuration is provided such that power lines are overlapped in planar on both of the semiconductor chip 3 for driving scan lines and the semiconductor chip 4 for driving signal lines, it may be applied to either one, of course.

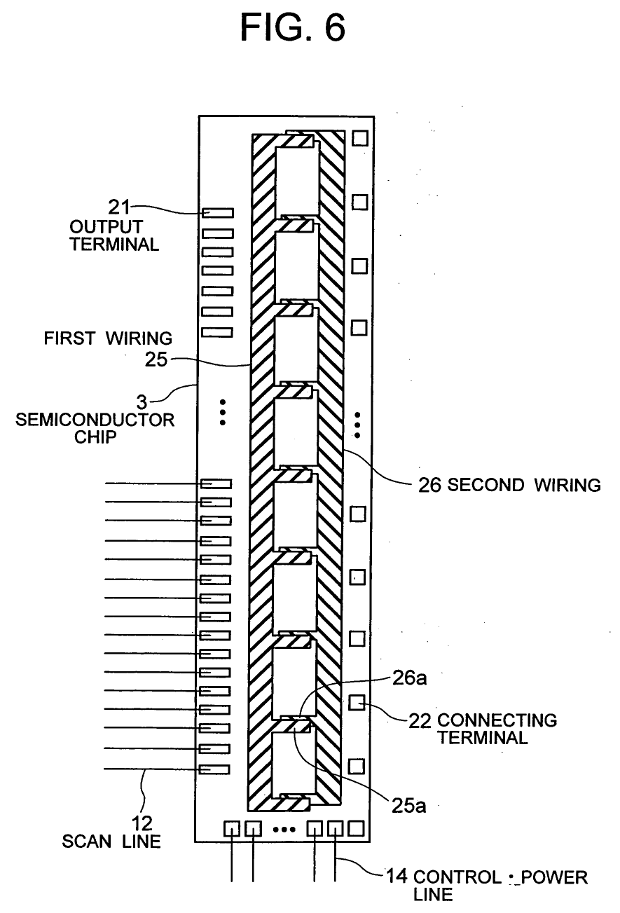

The second embodiment of the present invention will be described in detail with reference to the drawings. FIG. 6 illustrates a plan view of the configuration in semiconductor chip 3 for driving scan lines. Note that the configuration of a liquid crystal display device with the structure of this semiconductor chip 3 is the same as that of the FIG. 1 of a first embodiment.

What is different from the semiconductor chip 3 for driving scan lines in the FIG. 2 of a first embodiment is wirings extended in the continuous direction of a first wiring 25 and a second wiring 26 do not overlap. Rather, provided is the configuration that the regions among a plurality of branches 25a and 26a extended from each wiring over lap. Power lines with different electric potentials are assigned to each of the first wiring 25 and the second wiring 26. The overlapped plurality of branches 25a and 26a are arrayed in the longitudinal direction of the wirings 25 and 26 of power lines. In this manner, the effect of this invention can be obtained too under the configuration that a part of wirings overlaps in planar.

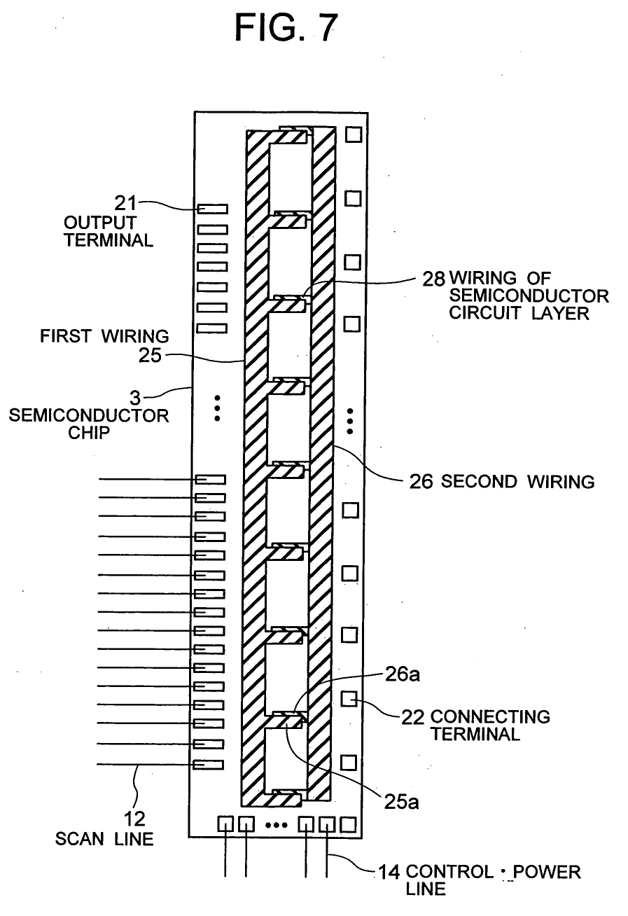

Moreover, considering that wirings extended in the continuous direction of a first wiring 25 and a second wiring 26 do not overlap, these wirings can be formed on the same process layer. In FIG. 7, the specific wiring configuration is shown. Wirings in the FIG. 7, which are extended in the continuous direction of a first wiring 25 and a second wiring 26, are formed in the same process layer. The areas of the branches 25a and 26a extended from each wiring are configured such that a wiring made at the same process layer where the first wiring 25 and the second wiring 26 are formed and a wiring 28 of a semiconductor circuit layer (specifically a wiring which are made at the same process layer as a gate line of a thin film transistor, for example) overlap in planar. Subsequently, in the FIG. 7, because there is an insulating layer between the second wiring 26 and the wiring 28 of a semiconductor circuit layer, each of the wirings is electrically connected by disposing a contact at the insulating layer.

In this manner, only the wirings with the form of a branch to be as another wiring layer, utilizing the wiring of a semiconductor circuit layer makes it possible to obtain the effect of this invention without having two layers on the semiconductor circuit layer as a wiring layer.

While the wiring 28 of a semiconductor circuit layer is connected only to the second wiring 26 in the configuration of FIG. 7, not limited to this, the wiring 28 of a semiconductor circuit layer and the wiring formed in the process layer of the first wiring 25 may be connected in a nested state.

As may be seen from the above configuration, by thinning wirings of a semiconductor chip, a structure which is capable of narrowing in width of a semiconductor chip can be provided. Also, from this effect, a display device with a narrower frame can be offered.

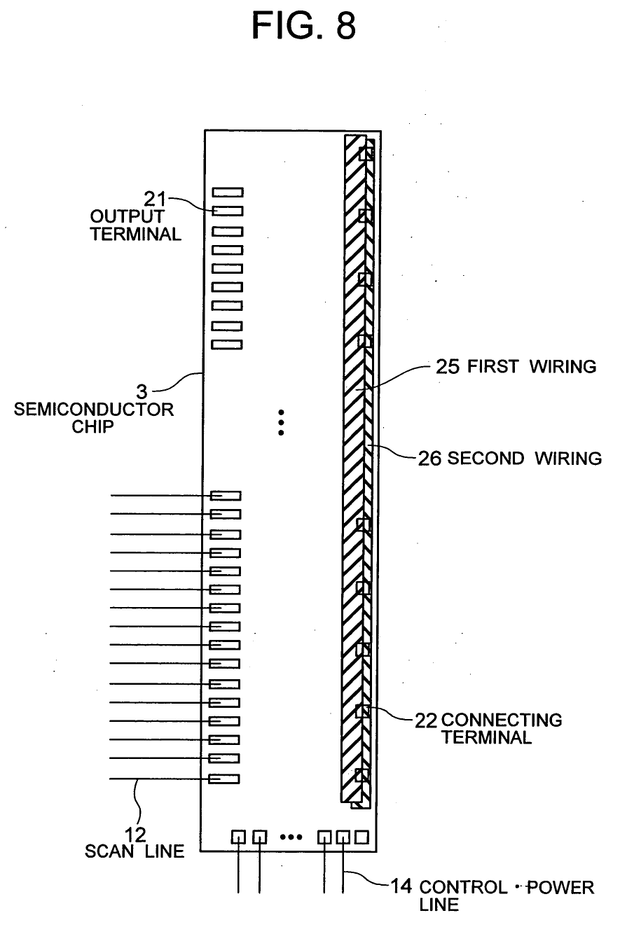

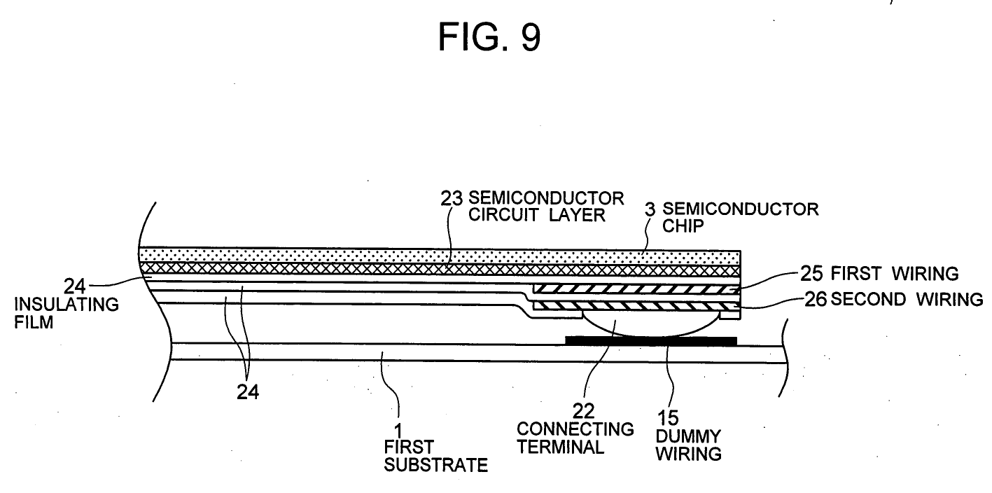

The third embodiment of the present invention will be described in detail with reference to the drawings. FIG. 8 illustrates a plan view of the structure of a semiconductor chip 3 for driving scan lines. Also, FIG. 9 shows a cross-sectional view of the right side portion in the semiconductor chip 3 of the FIG. 8. Note that the configuration of the display device in which the structure of this semiconductor chip 3 is used is the same as that of the FIG. 1 of a first embodiment.

What is different from the semiconductor chip 3 for driving scan lines in FIG. 2 of the first embodiment is at least a part of connecting terminals 22 parallel in the continuous direction of the semiconductor chip 3 and a second wiring 26 are placed by overlapping. Additionally, a first wiring 25 and a second wiring 26 are placed by overlapping. Other configurations and operations are the same as those of the first embodiment.

As shown in FIG. 9, by using a wiring where a connecting terminal 22, a dummy bump, is formed as a second wiring 26 and by placing this second wiring 26 and a first wiring 25 by overlapping, the areas of the dummy bump and the wiring can be overlapped.

As may be seen from the above configuration, by thinning wirings of a semiconductor chip, a structure which is capable of narrowing in width of a semiconductor chip can be provided. Also, from this effect, a display device with a narrower frame can be offered.

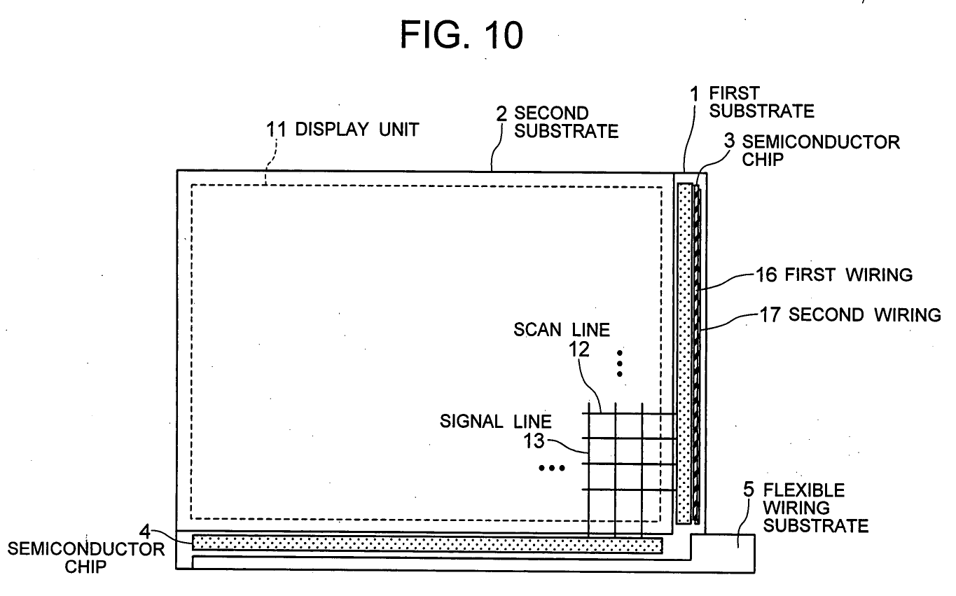

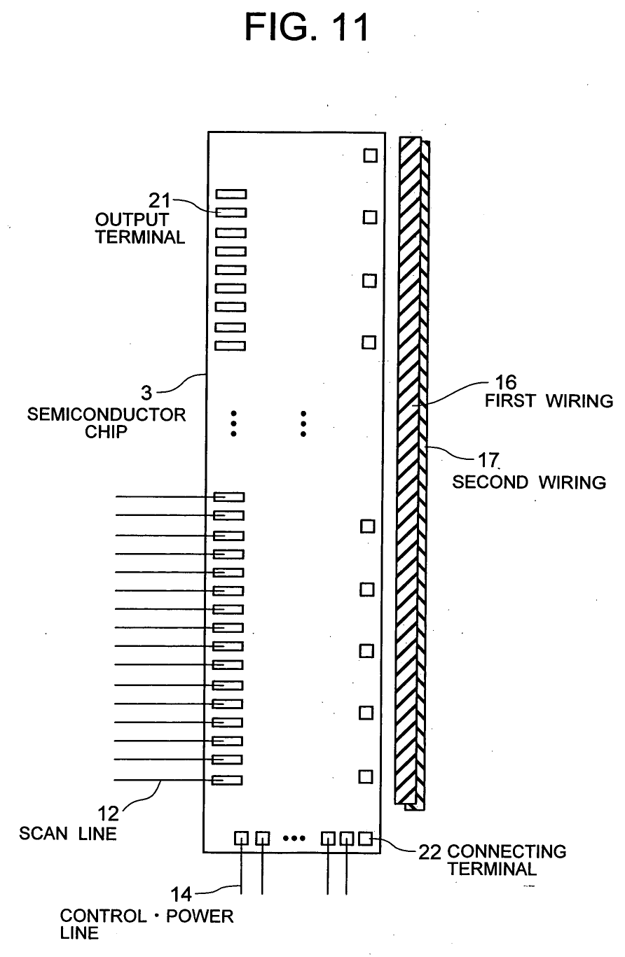

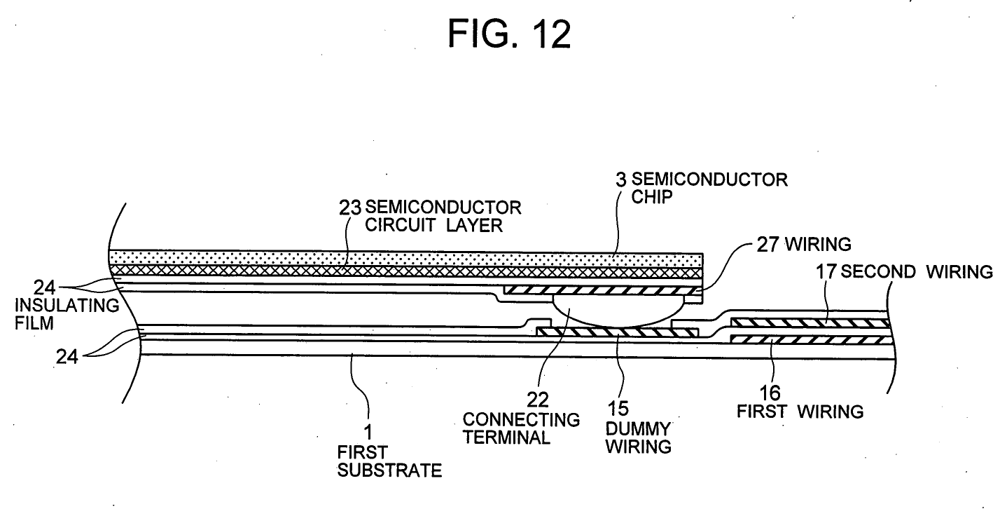

The fourth embodiment of the present invention will be described in detail with reference to the drawings. FIG. 10 is a plan view of a liquid crystal display device of the third embodiment of the present invention. FIG. 11 indicates a plan view of the structure of a semiconductor chip 3 for driving scan lines shown in FIG. 10 and wirings on a first substrate 1. Also, FIG. 12 illustrates a cross-sectional view of the right side portion in the semiconductor chip 3 in the FIG. 11.

Up until the third embodiment, power lines with different electric potentials are placed by overlapping in planar on a semiconductor chip 3 for driving scan lines or a semiconductor chip 4 for driving signal lines or the both. In contrast, this embodiment significantly differs in that the power lines with different electric potentials are placed on a first substrate 1 by overlapping in planar. That structure considerably differs in that a first wiring 16 and a second wiring 17 are placed on the first substrate 1 of a semiconductor chip 3 near the long side by overlapping in planar. Other configurations and operations are the same as those of the first embodiment.

Seeing the cross-sectional view of the right side portion of a first substrate 1 and a semiconductor chip 3 in FIG. 12, in the first substrate 1, after a first wiring 16 is formed, an insulating film 24 is placed entirely and then a first contact is disposed in a necessary position. Subsequently, after a second wiring 17 then again an insulating film 24 are placed, a second contact is disposed. Here, a dummy wiring 15 which is provided in the second embodiment is formed by the same process as the second wiring 17. In the FIG. 12, the first wiring 16 and the second wiring 17 which are placed on the right side of the dummy wiring 15 are to be, as power lines, with different electric potentials for each.

The first wiring 16 and the second wiring 17 are used as the power lines of a semiconductor chip 3. Consequently, it is needed to connect with a connecting terminal 22 at an appropriate position so as to connect with the semiconductor chip 3. As the methods of connection, for instance, connecting with the semiconductor chip 3 by a wiring used as the dummy wiring 15 up until the second embodiment or connecting with a connecting terminal 22 at another position is considered.

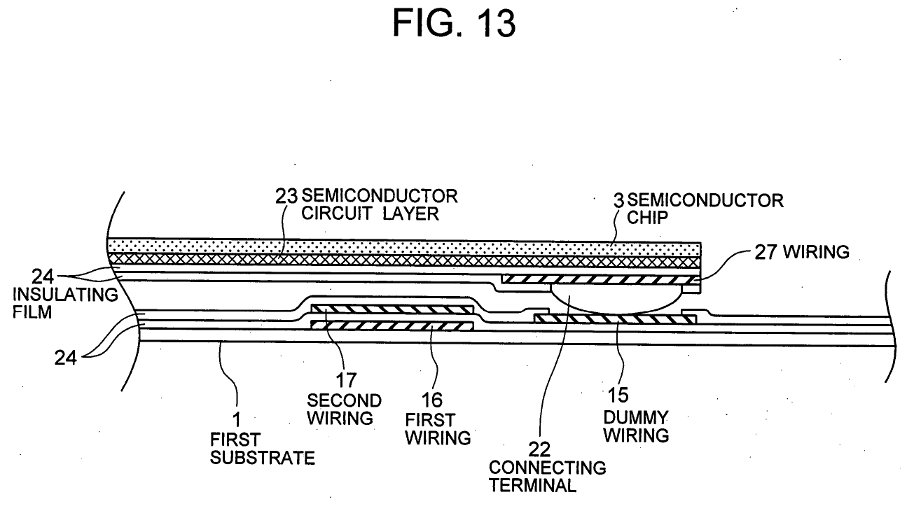

In the configuration of the liquid crystal display devices and the semiconductor chips shown from FIG. 10 to FIG. 12, a first wiring 16 and a second wiring 17 are provided in the positions which do not overlap with a semiconductor chip 3 in planar. However, it may be placed on the overlapped position in planar. FIG. 13 shows an example that power lines with different electric potentials placed by overlapping on a first substrate 1 is, in planar, placed with the semiconductor chip 3 by overlapping. The only difference with the FIG. 12 is the positions of a first wiring 16 and a second wiring 17, which are power lines. Such configuration allows a liquid crystal display device to be with a narrower frame.

In this embodiment, while power lines with different electric potentials are placed on the first substrate by overlapping in planar, power lines with different electric potentials may be placed by overlapping in planar inside the semiconductor chip too as shown up until the third embodiment.

As may be seen from the above configuration, by thinning wirings of a semiconductor chip, a structure which is capable of narrowing in width of a semiconductor chip can be provided. Also, from this effect, a display device with a narrower frame can be obtained.

Up until the fourth embodiment, it has been described mainly as to the embodiment in which a semiconductor chip is mounted on the glass substrate. In the fifth embodiment, another mounted form, specifically a form placed on a flexible wiring substrate and a printed board, is described. Even if the above semiconductor chip is mounted other than the glass substrate, the effect of this invention can be obtained.

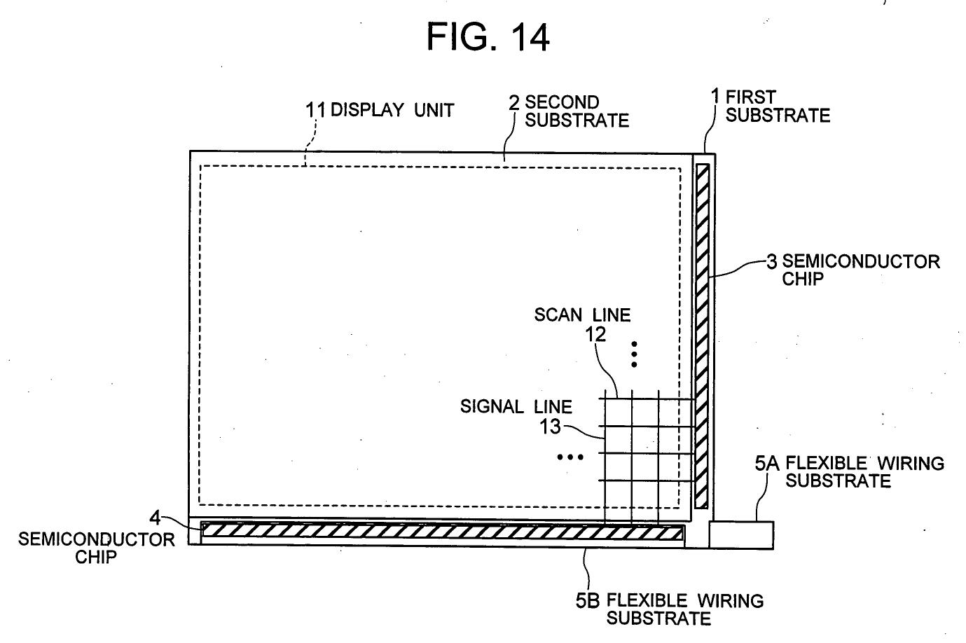

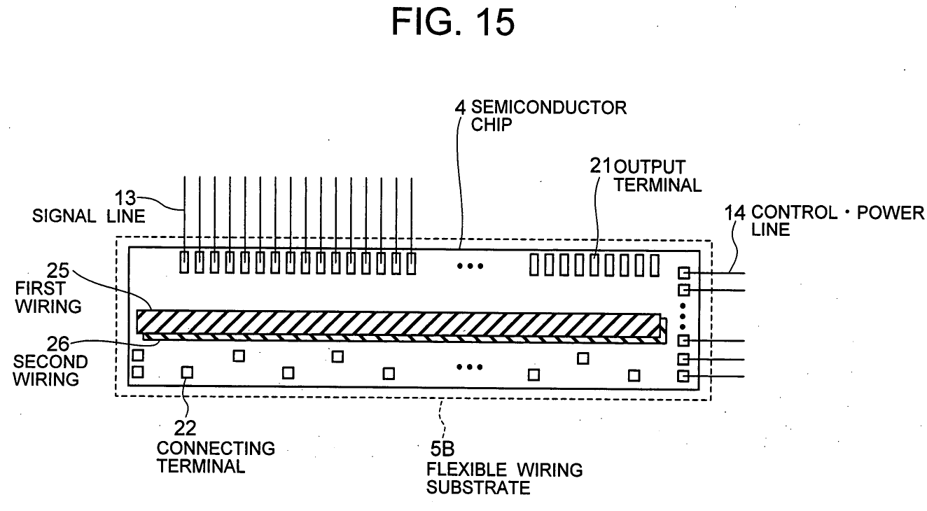

FIG. 14 is a plan view of a liquid crystal display device, which is the fifth embodiment of the present invention. FIG. 15 shows a plan view of a structure of a semiconductor chip 4 for driving signal lines illustrated in the FIG. 14 and the example of a wiring structure.

What is different from the FIG. 1 and the FIG. 4 of a first embodiment is that a flexible wiring substrate is divided into two. Subsequently, a flexible wiring substrate 5B is placed by overlapping with a semiconductor chip 4 for driving signal lines and provided between a semiconductor chip 4 for driving signal lines and a first substrate 1. Other points are the same as those of the first embodiment.

Signal lines 13 on a first substrate 1 and control lines•power lines 14 and a semiconductor chip 4 are connected through a wiring of a flexible wiring substrate 5B. That is, a signal line 13 on the first substrate 1 is electrically connected by a back connecting terminal (not shown) provided on the place of the first substrate 1 side of a flexible wiring substrate 5B. This back connecting terminal is connected with a front connecting terminal (not shown) provided on the plane of the semiconductor chip 4 side inside the flexible wiring substrate 5B. Then, this front connecting terminal is electrically connected with an output terminal 21 of a semiconductor chip 4. The connection between a control line•power line 14 and a connecting terminal 22 are in the same manner. On the other hand, although not shown, a wiring of a flexible wiring substrate 5B and a connecting terminal 22 are directly connected. This can be realized by mounting a semiconductor chip 4 on the flexible wiring substrate 5B. This indicates that the first substrate up until the third embodiment is replaced with a flexible wiring substrate. As illustrated in the above-mentioned configuration, a first wiring 25 and a second wring 26 can be placed by overlapping onto the semiconductor chip 4, whereby achieving the effect of the present invention too.

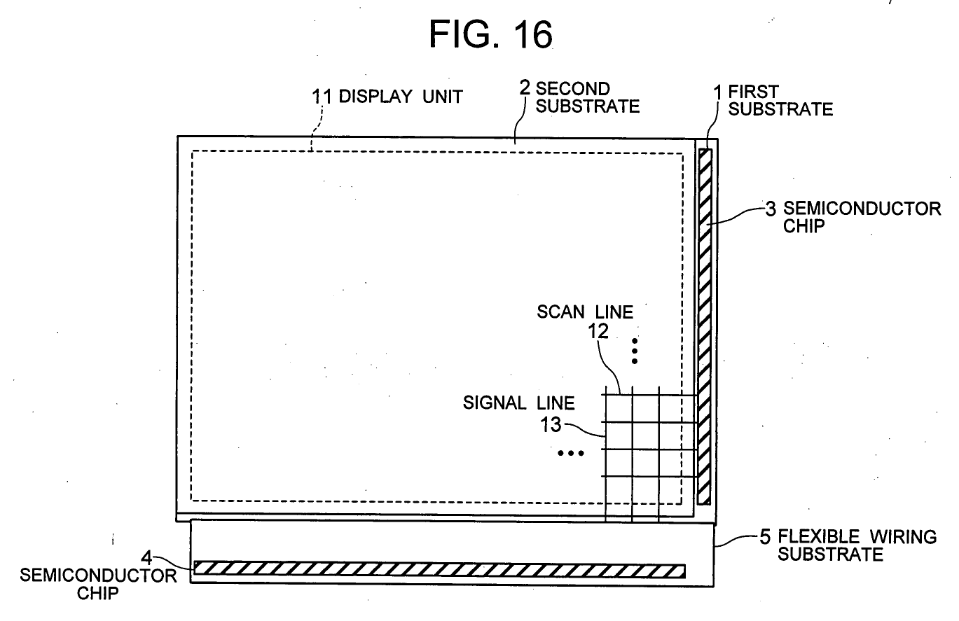

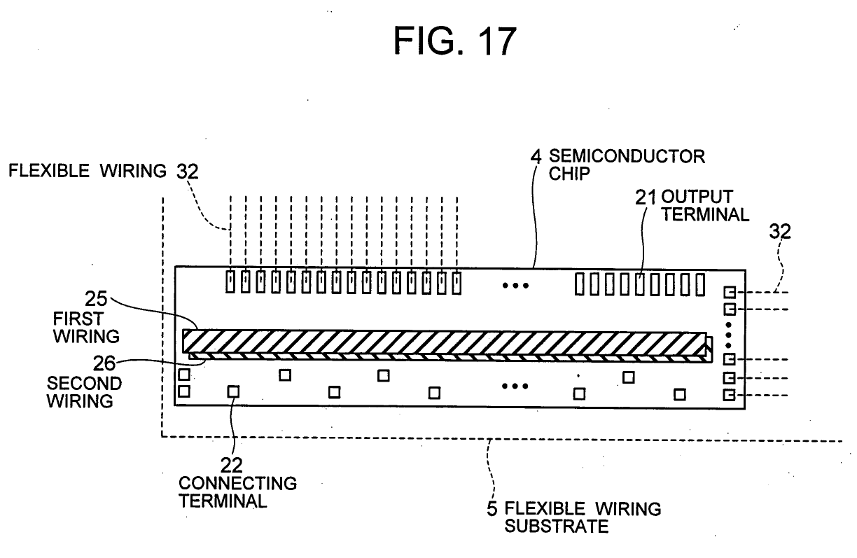

In the configuration of FIG. 14, although a semiconductor chip 4 for driving signal lines is placed by overlapping onto a first substrate 1, as shown in FIG. 16, a flexible wiring substrate 5 with a wider width than a frame part and a first substrate 1 may be so connected as to provide a semiconductor chip 4 for driving signal lines in other areas of the frame part in the first substrate 1. In this case, in the FIG. 16, for connecting a signal line 13 and a control line•power line 14 which are provided onto the first substrate 1, a flexible wiring 32 is provided on a flexible wiring substrate 5 as shown in FIG. 17, and then is used respectively in connecting with an output terminal 21 and a signal line 13 and with a connecting terminal 22 and a control line•power line 14. Even with the above configuration, the effect of the present invention can be obtained.

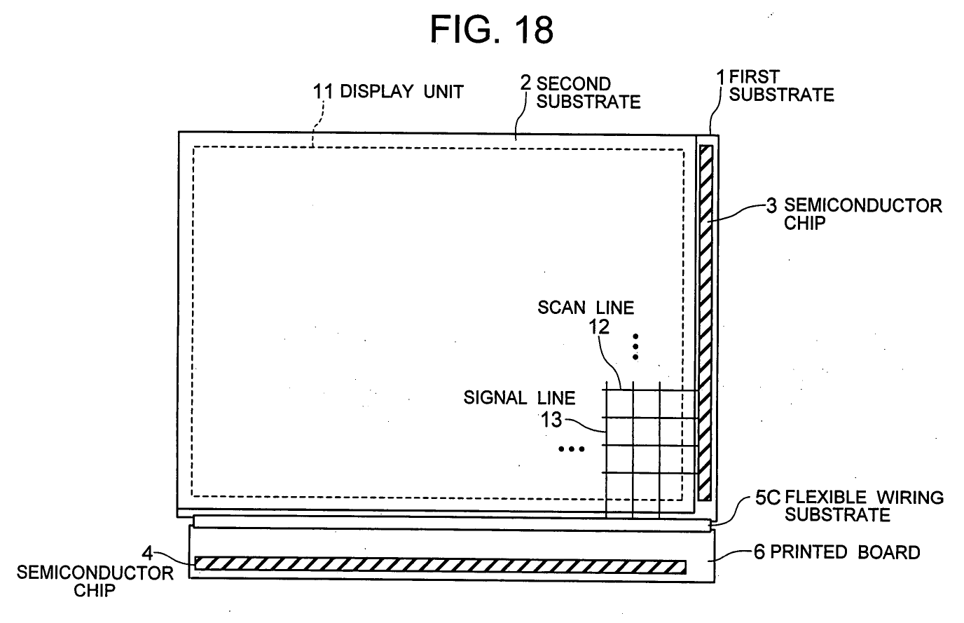

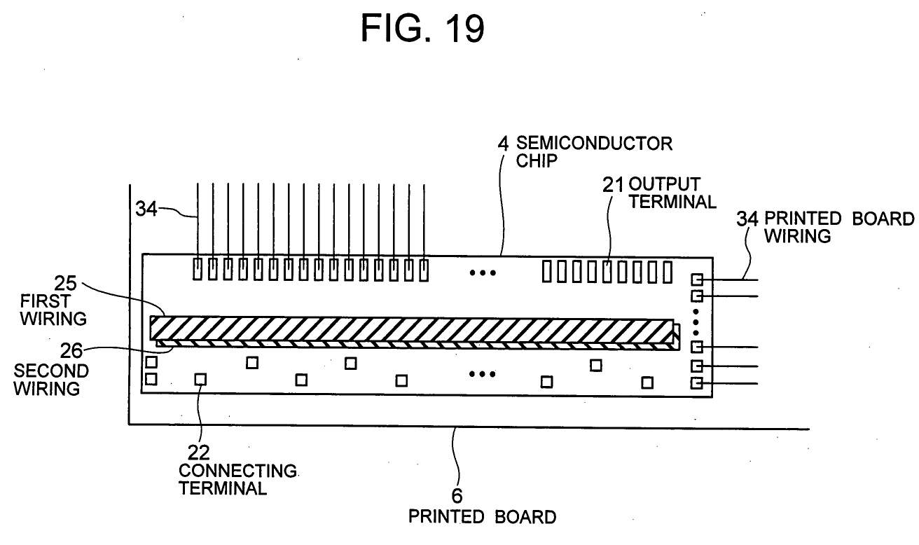

Examples when the configuration of a flexible wiring substrate in FIG. 16 is applied to a printed board are shown in FIG. 18 and FIG. 19. The differences in a liquid crystal display device between in FIG. 18 and FIG. 16 are: a flexible wiring substrate 5 in the FIG. 16 is replaced with a printed board 6; flexible wirings 32 are replaced with wirings 34 of the printed board; and the connection between the printed board 6 and a first substrate 1 is performed through another flexible wiring substrate 5C. In the plan view of a semiconductor chip in FIG. 19 also, the configuration has been modified from FIG. 17 according to the differences explained above. Other configurations are the same as those in the FIG. 16 and the FIG. 17. Hence, even by mounting a semiconductor chip 4 for driving signal lines on the printed board 6, the effect of this invention can obviously be obtained. Although a printed board is applied to in these examples, the effect of the present invention can also be achieved even with a glass substrate.

As may be seen from the above configuration, by thinning wirings of a semiconductor chip, a structure which is capable of narrowing in width of a semiconductor chip can be provided. Also, from this effect, a display device with a narrower frame can be obtained.

Although some embodiments of the present invention have been described, of course, it is allowed to combine in order to make a configuration from each configuration in these embodiments within the scope of possibility. With respect to each embodiment of this invention, as the configuration of a semiconductor chip, some has explained a semiconductor chip 3 for driving scan lines or a semiconductor chip 4 for driving signal lines as an example. However, it is not limited to this. This invention has applicability, for each, to other semiconductor chips for driving a signal line, semiconductor chips for driving a scan line and semiconductor chips. Additionally, in the embodiments of this invention, a liquid crystal display device has been explained as an example, not limited to this, the present invention is applicable as long as a display device has the configuration in which a driving circuit semiconductor chip is placed in each side of the display device, such as the one which uses organic EL.

1. A structure of a semiconductor chip comprising:
a semiconductor chip which includes a semiconductor circuit; and
a pair of power lines whose electric potentials are different for applying a voltage to the semiconductor circuit, wherein
the pair of power lines are to be confronted across a dielectric as an electrode plate and a capacitor is configured by the power lines and the dielectric.

2. The structure of a semiconductor chip, as claimed in claim 1, wherein the dielectric is an insulating layer which electrically insulates between the pair of power lines.

3. The structure of a semiconductor chip, as claimed in claim 1, wherein the pair of power lines are formed in an elongated planar shape and the entire area is confronted.

4. The structure of a semiconductor chip, as claimed in claim 1, wherein a part of a confronting area in the pair of power lines is enlarged so that a capacitance is incremented.

5. The structure of a semiconductor chip, as claimed in claim 1, wherein only branches with a narrow width provided in the pair of power lines are confronted across a dielectric.

6. The structure of a semiconductor chip, as claimed in claim 5, wherein the branches with a narrow width are arrayed plural in a longitudinal direction of the power lines.

7. The structure of a semiconductor chip, as claimed in claim 1, wherein the pair of power lines are shifted and disposed onto a string of terminals formed in an other side opposite of a side of the semiconductor chip, in which the string of output terminals of the semiconductor circuit is formed.

8. The structure of a semiconductor chip, as claimed in claim 1, wherein the pair of power lines are formed inside the semiconductor chip.

9. The structure of a semiconductor chip, as claimed in claim 1, wherein the pair of power lines are formed in a separate substrate from the semiconductor chip.

10. The structure of a semiconductor chip, as claimed in claim 1, wherein the semiconductor chip has the semiconductor circuit formed onto a glass substrate.

11. A display device comprising:
a display unit which contains a plurality of display pixels in a matrix shape;
a semiconductor chip which includes a semiconductor circuit for driving a display pixel of the display screen; and
a pair of power lines whose electric potentials are different for applying a voltage to the semiconductor circuit, wherein
the pair of power lines are to be confronted across a dielectric as an electrode plate and a capacitor is configured by the power lines and the dielectric.
